(19) United States
(12) Patent Application Publication
(10) Pub. No.: US 2003/0058838 A1
(43) Pub. Date: Mar. 27, 2003

(54) System and method for transmitting information via a call center SIP server

(76) Inventor: Michael Wengrovitz, Concord, MA (US)

Correspondence Address: ALCATEL INTERNETWORKING SYSTEM, INC., ALCATEL-INTELLECTUAL PROPERTY DEPARTMENT, 3400 W. PLANO PARKWAY, MS LEGL2, PLANO, TX, 75075, US

(21) Appl. No.: 09/990,852

(22) Filed: Nov. 21, 2001

Related U.S. Application Data
(60) Provisional application No. 60/317,746, filed on Sep. 6, 2001.

(51) Int. Cl. H04L 12/66; H04L 12/56

(52) U.S. Cl. 370/352; 370/401

(57) ABSTRACT

An enhanced session initiation protocol (SIP) server is located at a call center for generating message bodies to be included within SIP request and/or response messages. A particular message body may provide information to a caller regarding status of a current call. If the call is unauthorized, the message body may further provide the caller with instructions as to the steps that need to be taken to become authorized. If the call is authorized, the message may provide the caller with other personalized information and/or promotional information in addition to the call status message. The SIP server may further compose messages to be transmitted to a call center agent. The SIP messages sent to the call center agent may include the caller's profile information for allowing the agent to have the information on hand prior to voice conversation.

### CROSS-REFERENCE TO RELATED APPLICATION(S)

This application claims the benefit of U.S. provisional application No. 60/317,746, filed Sep. 6, 2001, the content of which is incorporated herein by reference.

### FIELD OF THE INVENTION

This invention relates generally to internet telephony, and more particularly, to transmitting information created by a session initiation protocol (SIP) server located at a call center using SIP request and/or response messages.

### BACKGROUND OF THE INVENTION

Call centers traditionally provide a communication link between callers and callees, such as, for example, between consumers and businesses. In a typical application, a consumer places a telephone call via a standard public telephone network to an 800 number of a call center. Upon receipt of the call, the call center transfers the call to an appropriate call center agent who services the consumer's requests. The consumer may then get personalized service through voice discussions with the call center agent regarding sales, service, account status, and the like.

Advanced call centers typically utilize computer telephony integration (CTI) technology to automatically route an incoming call to an appropriate agent and provide to the agent caller-specific information that may be retrieved from a call center database. The retrieved information is displayed on the agent's terminal via a screen-pop.

The availability of caller-specific information in servicing a particular call aids in providing good customer service and customer relations. However, deploying screen-pop technology to call centers using conventional telephony networks is generally complex, requiring numerous interfaces between the telephone switch, call routing engine, CTI client on the agent's terminal, and CTI server on the call center data network.

As telephony networks evolve from conventional circuit-switched public telephone networks to packet-switched internet protocol (IP) networks, the technology in call centers should similarly evolve. It is desirable for call centers to support new forms of communication provided by the IP networks and allow better customer service to be provided by exploiting capabilities provided by IP telephony protocols such as, for example, a session initiation protocol (SIP).

SIP is a signaling protocol for creating, modifying, and terminating multimedia sessions with one or more participants. These sessions include Internet multimedia conferences, Internet telephone calls, and multimedia distributions, presence, and instant messaging. Details about SIP are set forth in the Internet Engineering Task Force Request for Comment 2543 entitled “SIP: Session Initiation Protocol,” March 1999 (hereinafter referred to as RFC 2543), which is incorporated herein by reference.

Although SIP end-points can directly place IP calls to one another, SIP servers, including proxy and redirect servers, are typically engaged during the call set-up process to route calls. Such call routing includes ascertaining called end-points in response to call establishment messages, referred to as INVITE messages, originated by the calling end-points. The INVITE messages are either proxied to ascertained called end-points, or addresses of ascertained called end-points are returned to the calling end-points by a redirect SIP server. The SIP server further transmits SIP response messages to calling end-points indicating the progress and/or outcome of a SIP request.

SIP makes provisions for transmitting messages in the body of SIP request and response messages. It is desirable for call centers to take advantage of the provisions made by SIP to transmit such messages for providing better customer service and customer relationship management.

### SUMMARY OF THE INVENTION

The present invention is directed to a system and method for transmitting information created by a call center server. According to one embodiment, the invention is directed to an internet protocol (IP) telephony system supporting an IP telephony session. The system includes a calling end-point transmitting a request message for establishing a session with a called end-point, a display coupled to the calling end-point for displaying information to a calling user, a data store including information associated with the calling user, and a routing device coupled to the data store and the calling end-point. The routing device according to one embodiment is a SIP server located at a call center. The routing device receives the request message and composes a response message having a message body. The message body is personalized based on information retrieved from the data store. The routing device transmits the response message to the calling end-point for display of the message body to the calling user.

According to another embodiment of the invention, the IP telephony system includes a data store including promotional information. The routing device receives the request message and composes a response message having a message body. The message body includes promotional information retrieved from the data store. The routing device transmits the response message to the calling end-point for display of the message body to the calling user.

In a further embodiment, the IP telephony system includes a calling end-point, a called end-point, a display coupled to the called end-point for displaying information to a called user, a data store including information about a calling user, and a routing device coupled to the data store for establishing a SIP session between the calling end-point and the called end-point. The routing device receives a first SIP message from the calling end-point and composes a second SIP message having a message body. The message body includes information about the calling user retrieved from the data store. The routing device transmits the second SIP message to the called end-point for display of the information to the called user.

It should be appreciated, therefore, that allowing a call center server to transmit information in message bodies yields important benefits to both consumers and businesses. Consumer benefits may include, without limitation, accessing relevant personal data, receiving targeted advertisements, and receiving information on expected waiting times. Call center benefits may include, without limitation, providing information needed for a call prior to voice conversation to reduce agent time with a particular caller, increased sales due to targeted advertisements, and improved efficiency and customer relationship management.

### DESCRIPTION OF THE DRAWINGS

These and other features, aspects and advantages of the present invention will be more fully understood when considered with respect to the following detailed description, appended claims, and accompanying drawings where:

FIG. 1 is a schematic block diagram of a communication system supporting IP telephony sessions according to one embodiment of the invention;

FIG. 2 is a layout diagram of an exemplary SIP message according to one embodiment of the invention;

FIG. 3 is a functional block diagram of messages exchanged when a call is unauthorized according to one embodiment of the invention;

FIG. 4 is a functional block diagram of messages exchanged when a call is authorized according to one embodiment of the invention;

FIG. 5 is a functional block diagram of messages exchanged when a call is authorized according to another embodiment of the invention; and

FIG. 6 is a flow diagram of a process for handling incoming SIP calls according to one embodiment of the invention.

### DETAILED DESCRIPTION OF THE SPECIFIC EMBODIMENTS

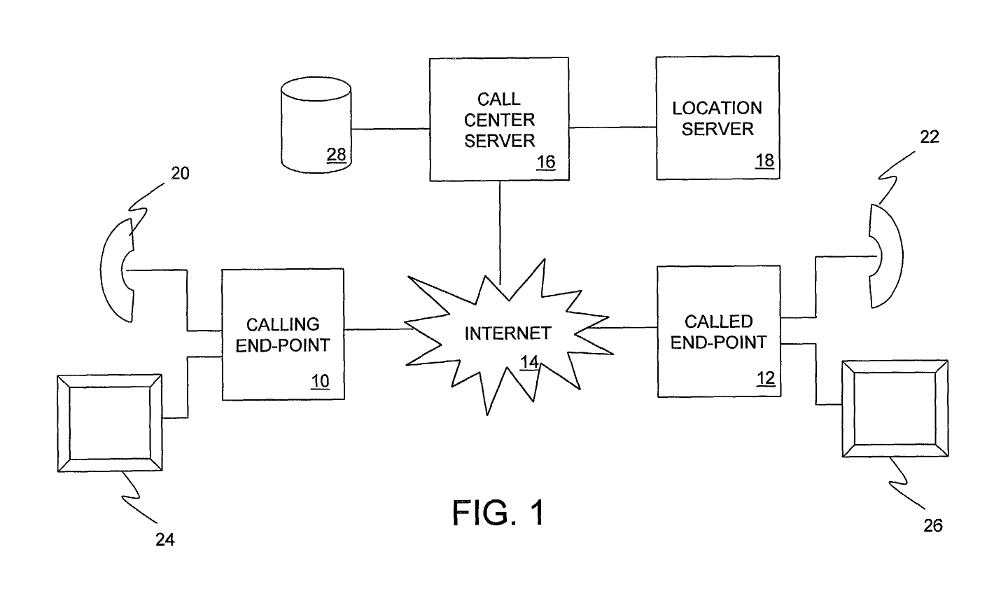

FIG. 1 is a schematic block diagram of a communication system supporting IP telephony sessions according to one embodiment of the invention. The system includes a calling end-point 10 initiating a call that is directed to a called end-point 12 over a wide area network, such as, for example, a public internet 14. The calling end-point 10, called end-point 12, and internet 14 preferably adhere to the SIP signaling protocol set forth in RFC 2543. A person skilled in the art should recognize, however, that any other IP telephony protocol conventional in the art may be used in place of SIP.

The calling and called end-points 10, 12 are preferably SIP-enabled telephones, hand phones, personal computers, switches, routers, and/or the like. Preferably, each calling and called end-point is associated with a handset 20, 22 for receiving and transmitting voice between a caller and callee. Each calling and called end-point is further associated with a display device 24, 26 to present information to a caller or callee during or after a connection attempt. The display device 24, 26 may be a LCD screen, PC monitor, television monitor, and/or any other type of display terminal known in the art with at least a capability of displaying plain text messages.

The communication system of FIG. 1 further includes a call center server 16 acting as a routing device for routing calls between the calling and called end-points 10, 12. The server 16 is preferably coupled to a location server 18 containing location information used for routing the calls.

The server 16 is preferably an enhanced SIP proxy or redirect server as set forth in RFC 2543, located at a particular call center. The server 16, however, may adhere to any other IP telephony protocol conventional in the art.

The server 16 preferably includes logic for constructing message bodies for delivery in a response or request message. The message bodies are preferably SIP message bodies delivered in SIP response and/or request messages.

The message bodies preferably provide to a caller and/or callee, information related to the current call. For example, the message body may include text indicating an expected waiting time for a next available customer service representative. The message body may also contain promotions, advertisements, marketing information (collectively referred to as promotional information) that may or may not be related to the call.

The server 16 preferably retrieves information to be included in the message body from a mass storage device 28 taking the form of a hard disk drive or drive array. The mass storage device 28 may also contain profile information of various callers, including their preference information, account information, transaction history, billing history, demographic information, and/or other information that may be used for personalizing the content of the message body.

In another embodiment, the information to be included in the message body is derived by a CPU processor, using information in a data store and/or based on rules and processing logic for personalizing the content of the message.

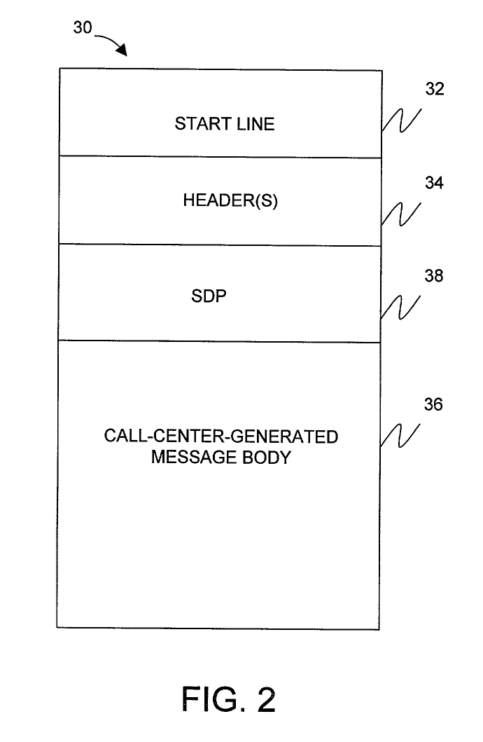

FIG. 2 is a layout diagram of an exemplary SIP message 30 according to one embodiment of the invention. The SIP message 30 is preferably transmitted by the call center server 16 to the calling or called end-points as either a response or request SIP message. The SIP message 30 preferably includes a start line 32, one or more headers 34, and a SIP message body 36 generated by the call center SIP server 16. The SIP message 30 may optionally include a session description 98 originated by the calling end-point 10 if the SIP message is a request SIP message. The session description 98 preferably adheres to a session description protocol (SDP) set forth in Network Working Group Request for Comments 2327 entitled “SDP: Session Description Protocol,” April 1998, the content of which is incorporated herein by reference.

The start line 32 preferably indicates a type of request for a request SIP message or call status information for a response SIP message. The request type may be an INVITE, ACK, or any other type of request message set forth in RFC 2543. The call status information may include an outcome of an attempt to understand and satisfy the request.

The header 34 preferably includes fields for depicting contact addresses, the media type of the SIP message body 36, the length of the SIP message body 36, and other header information as set forth in RFC 2543. The session description 38, if included in the SIP message, preferably enumerates the media types, formats, and addresses to be used during a current SIP session.

The SIP message body 36 may be a hypertext transfer markup language (HTML) page, uniform resource locator (URL) link, plain text, graphics, video, or any other standard message body type supported by SIP. The message body may further be encrypted and/or compressed.

According to one embodiment of the invention, the content of the message body 36 is either generic or personalized based on the caller profile information. If the message is personalized, the call center server 16 preferably retrieves the caller's profile information from the database 28 and constructs a message that is customized for the caller. For example, a personalized message for a caller that has exceeded an allotted number of calls to a technical support call center may read: “Sorry Mr. Smith, you last purchased a 10-call technical support plan on Jan. 13, 2001, which now has been fully utilized. In order to purchase additional support, please access this URL: www.buymoretechsupport.com.”

In this example, the name of the caller, the number of allowed calls in the purchased plan, and the date of the purchase of the plan are stored in the database 28 for the caller and retrieved accordingly for generating the message body. The message body 36 is preferably included in a response message and transmitted to the caller in denying the call request. With the personalized message, the caller may have a better understanding as to why the call was rejected, and the next steps that should be taken in response. The personalized message preferably promotes better customer relations than a generic message, such as, for example, a generic call-unauthorized message, that may not be very helpful to the caller.

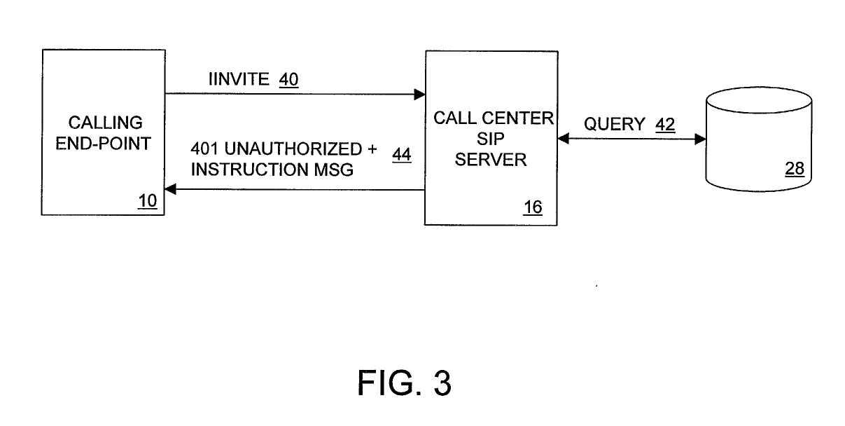

FIG. 3 is a functional block diagram of messages exchanged when a call is unauthorized according to one embodiment of the invention. In step 40, the calling end-point 10 transmits a request message, such as, for example, a SIP INVITE message, to the call center server 16. In step 42, the server 16 examines the database 28 for determining caller authorization information. For instance, authorization may be necessary for transfer of personal data to the caller, such as, for example, bank account balance status and details.

If the caller is not authorized, the server generates a response message, such as, for example, a SIP response message, where the start line 32 includes a status code, such as, for example, status code “401,” indicating that the call was unauthorized. In addition, the server 16 generates a message body to be included in the response message, informing the caller as to why a voice connection could not be established. The message body preferably further provides instructions of the steps that the caller may take next. For example, the caller may be provided with a URL of a web page to visit to enter registration data, select various personal options, and become authorized. In step 44, the response message including the status code and message body is transmitted to the calling end-point. The message body is then displayed on the caller's display 24.

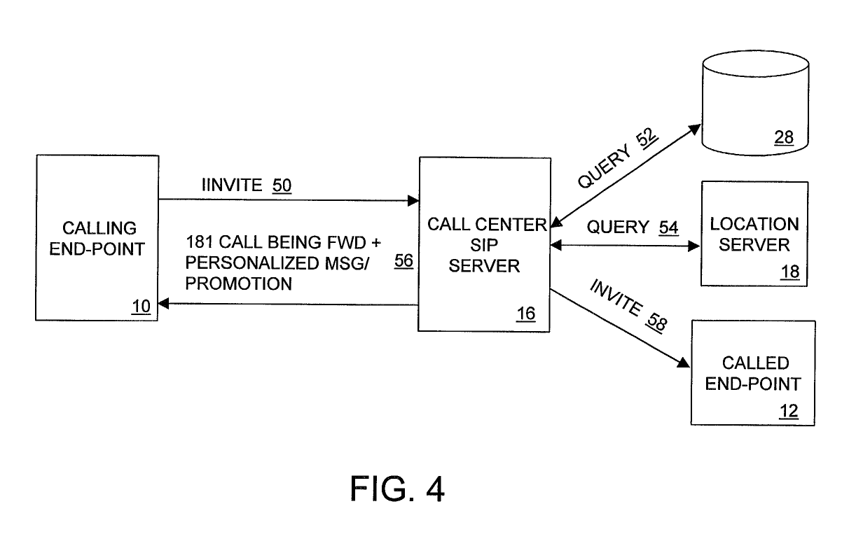

FIG. 4 is a functional block diagram of messages exchanged when a call is authorized according to one embodiment of the invention. In step 50, the calling end-point 10 transmits a request message, such as, for example a SIP INVITE message, to the call center server 16. In step 52, the server 16 examines the database 28 for determining caller authorization. If the caller is authorized, the server 16, in step 54, obtains from the location server 18 an address of the called end-point to which to forward the call. The server 16 further generates a response message, such as, for example, a SIP response message, where the start line 32 includes a status code, such as, for example, status code “181,” indicating that the call is in the process of being forwarded. In addition, the server 16 generates a message body to be included in the response message.

According to one embodiment of the invention, the message body contains personalized information that is targeted for the particular caller. In its simplest form, the message body may be personalized to begin each message with the caller's name. The message body may also be personalized to include the caller's personal information, such as, for example, the caller's account information, allowing the caller to review this information while waiting to be connected to a customer service representative. In another example, the message body may include the caller's personalized airline mileage information, a list of current airline destinations with special fares, a polite request to the caller to have an existing airline flight number and departure date/time information ready and on-hand for the agent, and the estimated waiting time before an agent becomes available.

According to another embodiment of the invention, the message body contains advertisements and other promotional information that may or may not be targeted to the particular caller. If the ads are targeted, the server 16 retrieves ads from the database 28 based on particular characteristics of the user, such as, for example, based on the caller's age, gender, interests, and/or the like. If the ads are not targeted, the ads to be transmitted may be selected in a round robin fashion or according to any selection mechanism conventional in the art.

In step 56, the server 16 transmits the response message with the personalized message and/or ads to the calling end-point. In step 58, the server 16 transmits a new request message, such as, for example, a SIP INVITE message, to the destination address retrieved from the location server.

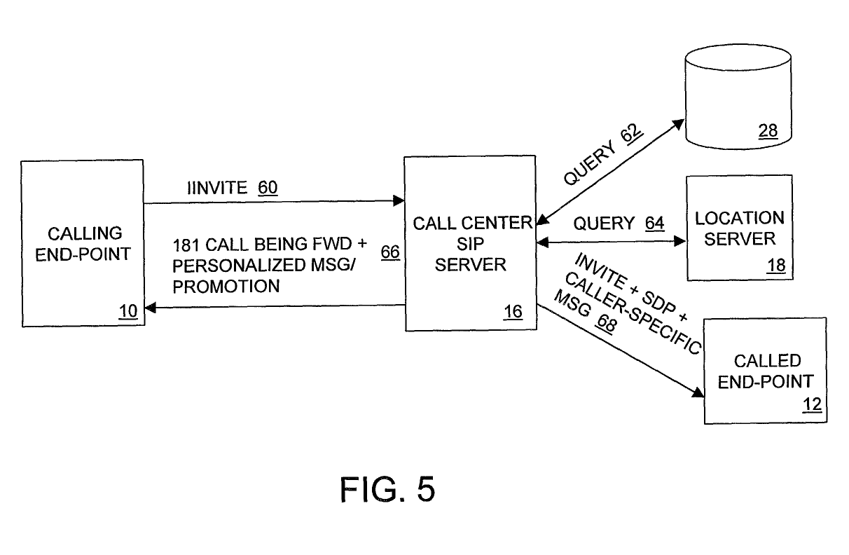

FIG. 5 is a functional block diagram of messages exchanged when a call is authorized according to another embodiment of the invention. In step 60, the calling end-point 10 transmits a request message, such as, for example, a SIP INVITE message, to the call center server 16. In step 62, the server 16 examines the database 28 for determining caller authorization information. If the caller is authorized, the server 16, in step 64, obtains from the location server 18 an address of the called end-point to which to forward the call. The server 16 further generates a response message where the message body 56 contains a personalized message and/or ads, and transmits the SIP response message to the calling end-point in step 66.

In addition to the message body transmitted to the calling end-point, the server further composes a message body for the called end-point and, in step 68, includes the newly constructed message body in a new request message, such as, for example, a SIP INVITE message. The server 16 transmits the new request message to the address retrieved from the location server. If the new request message is a SIP INVITE message, the server 16 further forwards in the new request message a session description originated by the calling end-point that was received with the original INVITE message.

The message body generated for the called end-point preferably includes caller-specific information, such as, for example, the caller's name, address, purchase history, payment history, general account information, and/or other information that may be traditionally deployed to call centers via public telephony networks. By transmitting such information in the message body during call set-up, the call center agent has the caller-specific information available by the time voice conversation ensues, thereby allowing the call center agent to greet the caller by name and immediately see other information about the caller. Furthermore, the transmission of such caller-specific information within the body of the request message helps avoid complex interactions between the PBX and CTI clients and CTI servers in transmitting the same information using public telephony networks.

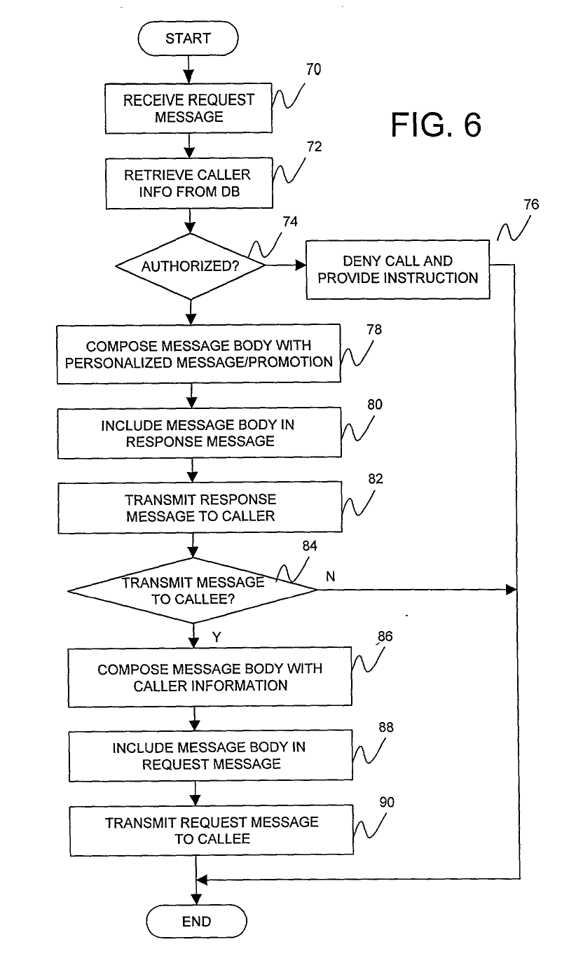

FIG. 6 is a flow diagram of a process of handling incoming calls according to one embodiment of the invention. In step 70, the call center server 16 receives a request message, such as, for example, a SIP INVITE message from the calling end-point 10. In step 72, the server 16 proceeds to retrieve caller information from the database 28. In doing so, the server 16 places a query on the database 28, preferably based on caller-id information extracted from the “From:” field of the message header. Upon finding an entry associated with the caller-id, the server 16 retrieves information stored for the caller. Part of the stored information may be the caller's authorization information. If the caller is not authorized to place the call, as determined in step 74, the server 16 denies the call and preferably provides instructions retrieved from the database 28 as to the reason for the denial as well as instructions on how to proceed next.

If the call is authorized, the server 16 proceeds to compose, in step 78, a message body with a personalized message and/or promotional information catered for the caller. The server 16 preferably analyzes the user's profile information retrieved from the database 28 in order to create the personalized message and/or select promotional information customized for the caller. If personal data is to be transmitted in the message body, the server 16 may further encrypt the data using standard encryption techniques. For instance, the data may be encrypted using the caller's PGP public key.

In step 80, the server 16 includes the message body in a response message. In step 82, the server 16 transmits the response message to the caller.

In step 84, a determination is made as to whether a separate message body is to be composed to be transmitted to the callee for allowing the callee to obtain information about the caller prior to engaging in voice conversation. If the answer is YES, the server 16 proceeds to compose, in step 86, the message body with the caller's information retrieved from the database 28. In step 88, the server includes the message body in the request message transmitted to the callee. If the request message is a SIP INVITE message, the newly composed message body is preferably included in addition to the standard session description originated from the calling end-point 10. In step 90, the request message is transmitted to the callee.

Although this invention has been described in certain specific embodiments, those skilled in the art will have no difficulty devising variations which in no way depart from the scope and spirit of the present invention. For example, although the call center server 16 is often described in terms of a proxy SIP server, a person skilled in the art should recognize that the server may also take the form of a redirect SIP server or any other IP telephony protocol server known in the art. As another example, the call center server may direct the form of messages exchanged to the caller or callee within instant messages. It is therefore to be understood that this invention may be practiced otherwise than is specifically described. Thus, the present embodiments of the invention should be considered in all respects as illustrative and not restrictive, the scope of the invention to be indicated by the appended claims and their equivalents rather than the foregoing description.

What is claimed is:

1. An internet protocol (IP) telephony system supporting an IP telephony session, the system comprising:
a calling end-point transmitting a request message for establishing a session with a called end-point;
a display coupled to the calling end-point for displaying information to a calling user;
a data store including information associated with the calling user; and
a routing device coupled to the data store and the calling end-point, the routing device receiving the request message and composing a response message having a message body, the message body being personalized based on information retrieved from the data store, the routing device transmitting the response message to the calling end-point for display of the message body to the calling user.

2. The system of claim 1, wherein the message body includes instructions for the calling user.

3. The system of claim 1, wherein the message body informs the calling user of an approximated waiting time prior to connection with the called end-point.

4. The system of claim 1, wherein the message body is displayed to the calling user while awaiting connection with the called end-point.

5. The system of claim 1, wherein the routing device is a session initiation protocol server located at a call center.

6. The system of claim 1, wherein the information is user profile information.

7. An internet protocol (IP) telephony system supporting a IP telephony session, the system comprising:
a calling end-point transmitting a request message for establishing a session with a called end-point;
a display coupled to the calling end-point for displaying information to a calling user;
a data store including promotional information; and
a routing device coupled to the data store and the calling end-point, the routing device receiving the request message and composing a response message having a message body, the message body including promotional information retrieved from the data store, the routing device transmitting the response message to the calling end-point for display of the message body to the calling user.

8. The system of claim 7, wherein the message body further includes instructions for the calling user.

9. The system of claim 7, wherein the message body further informs the calling user of an approximated waiting time for connection with the called end-point.

10. The system of claim 7, wherein the message body is displayed to the calling user while awaiting connection with the called end-point.

11. The system of claim 7, wherein the message body further includes personal data associated with the calling user.

12. The system of claim 7, wherein the routing device is a session initiation protocol server located at a call center.

13. The system of claim 7, wherein the promotional information is customized based on user profile information.

14. An internet protocol (IP) telephony system supporting a session initiation protocol (SIP), the system comprising:
a calling end-point;
a called end-point;
a display coupled to the called end-point for displaying information to a called user;
a data store including information about a calling user; and
a routing device coupled to the data store for establishing a SIP session between the calling end-point and the called end-point, the routing device receiving a first SIP message from the calling end-point and composing a second SIP message having a message body, the message body including information about the calling user retrieved from the data store, the routing device transmitting the second SIP message to the called end-point for display of the information to the called user.

15. The system of claim 14, wherein the information includes user profile information.

16. The system of claim 14, wherein the routing device is a SIP server located at a call center.

17. The system of claim 14, wherein the called user is a call center agent.

18. A method for establishing an internet protocol telephony session between a calling end-point and a called end-point, the method comprising:
transmitting a request message for establishing a session with the called end-point;
retrieving information of a calling user from a data store;
composing a message in response to the request message, the composed message being personalized based on the retrieved information;
including the composed message in a body of a response message;
transmitting the response message to the calling end-point; and
displaying to the calling user the message included in the body of the response message.

19. The method of claim 18, wherein the message includes instructions for the calling user.

20. The method of claim 18, wherein the message informs the calling user an approximated waiting time for connection with the called end-point.

21. The method of claim 18, wherein the message is displayed to the calling user while awaiting connection with the called end-point.

22. The method of claim 18, wherein the information is user profile information.

23. A method for establishing an internet protocol telephony session between a calling end-point and a called end-point, the method comprising:
transmitting a request message for establishing a session with the called end-point;
composing a message including promotional information in response to the request message;
including the composed message in a body of a response message;
transmitting the response message to the calling end-point; and
displaying to a calling user the message included in the body of the response message.

24. The method of claim 23, wherein the message further includes instructions for the calling user.

25. The method of claim 23, wherein the message further informs the calling user an approximated waiting time for connection with the called end-point.

26. The method of claim 23, wherein the message is displayed to the calling user while awaiting connection with the called end-point.

27. The method of claim 23, wherein the message further includes personal data associated with the calling user.

28. The method of claim 23, wherein the promotional information is customized based on user profile information.

29. A method for establishing a session initiation protocol (SIP) session between a calling end-point and a called end-point, the method comprising:
transmitting a first SIP message for establishing the SIP session with the called end-point;
retrieving information of a calling user from a data store;
composing a message including at least a portion of the retrieved information in response to the request SIP message;
including the composed message in a body of a second SIP message;
transmitting the second SIP message to the called end-point; and
displaying to a called user the message included in the body of the second SIP message.

30. The method of claim 29, wherein the information includes user profile information.

31. The method of claim 29, wherein the called user is a all center agent.
